(19) United States
(12) Patent Application Publication
(10) Pub. No.: US 2013/0200319 A1
(43) Pub. Date: Aug. 8, 2013

(54) HOIST WITH BUILT-IN LOAD SENSITIVE AUTOMATIC SPEED CHANGE DEVICE

(71) Applicant: Takayuki Kasai, Yamanashi (JP)

(72) Inventor: Takayuki Kasai, Yamanashi (JP)

(73) Assignee: KITO CORPORATION, Nakakoma-Gun, Yamanashi (JP)

(21) Appl. No.: 13/821,342

(22) PCT Filed: Sep. 6, 2011
(86) PCT No.: PCT/JP2011/070244

§ 371 Date: Apr. 26, 2013

(30) Foreign Application Priority Data
Sep. 10, 2010 (JP) 2010-202756

(51) Int. Cl. B66D 1/22

(52) U.S. Cl. CPC B66D 1/225
USPC 254/344

(57) ABSTRACT

A hoist with built-in load sensitive automatic speed change device includes: a high-torque input member coupled to a hand wheel, a magnetic clutch coupled via a speed-increasing mechanism and configured to transmit a low load, and an output transmitting means configured to transmit a rotational operating force of the hand wheel to mechanical brakes via the high-torque input member or magnetic clutch, wherein the hand wheel is axially supported by a drive member coupled to the output transmitting means of the mechanical brakes and rotated thereby, the magnetic clutch is arranged between the speed-increasing mechanism and the hand wheel, the hand wheel and the speed-increasing mechanism are coupled by a hollow input member provided so as to cover the outer periphery of the magnetic clutch, the output transmitting means is fitted onto a boss portion of the drive member so as to allow torque transmission to the boss portion.

### TECHNICAL FIELD

The present invention relates to a hoist with built-in load sensitive automatic speed change device and, more specifically, to a hoist with built-in load sensitive automatic speed changer in which the offset amount between a hand wheel and a load chain is small.

### BACKGROUND ART

In the related art, an automatic speed changer of a hoist including two clutch mechanisms and enabling high-speed hoisting when no load is applied is developed. However, since a contact-type switching system in which a transmission plate is mechanically slid is employed, there is a problem that an internal resistance at the time of switching is large, and hence the operability is not good. Therefore, a hoist with built-in load sensitive automatic speed change device in which an operator needs not to perform a cumbersome gear-shifting operation every time when the state of a load changes, and when hoisting a predetermined load or larger, is allowed to perform power transmission between a low-speed side rotating member and an output member smoothly, and hence an impact or a noise at the time of switching may be reduced is proposed by the present applicant (Patent Literature 1). Also, in the hoist described above, a device which realizes reduction in size of the load sensitive automatic speed change device is also proposed by the present applicant (Patent Literature 2) (Patent Literature 3).

Patent Literature 1: JP-A-2010-116957

Patent Literature 2: JP-A-2010-189080

Patent Literature 3: JP-A-2010-193860

### SUMMARY OF INVENTION

### Technical Problem

A hoist with built-in load sensitive automatic speed change device described above includes a low-speed side input rotation member coupled to a hand wheel and having an outer magnetic body configured to transmit a high load, a high-speed side input rotating member coupled to the low-speed side input rotating member via a rotational speed-increasing device and having an inner magnetic body configured to transmit a low load,
and an output member configured to be displaced in a direction of an axial line of axes of rotation of the both rotating members by position switching means configured to act according to the magnitude of the outside load, having an intermediate magnetic body configured to magnetically engage one of the magnetic bodies of the low-speed side input rotating member and the high-speed side input rotating member, and configured to perform switching between a low-load high-speed rotation and a high-load low-speed rotation,
the low-speed side rotating member includes an engaging portion configured to mechanically engage the output member,
the engaging portion is configured to engage the output member after the intermediate magnetic body of the output member faces and magnetically engages the outer magnetic body of the low-speed side input rotating member, and is configured to support the outer periphery of the low-speed side input rotating member coupled to the hand wheel by a bearing provided on an outer peripheral frame, so that a large-diameter bearing has to be used, and hence there is a problem of a high cost.

It is an object of the present invention to provide a hoist with built-in load sensitive automatic speed change device, which is less expensive and has a compact structure in comparison with the hoist by employing a configuration in which the offset amount between a hand wheel and a load chain is small, and a large-diameter bearing is not used.

### Solution to Problem

The present invention solves the above-described problem, and provides a hoist with built-in load sensitive automatic speed change device including: a speed-reducing mechanism configured to drive a load sheave axially supported by a frame on one side of the load sheave and a mechanical brake which applies a brake force by a load applied to the load sheave on the other side thereof;

a drive shaft configured to couple the speed-reducing mechanism and the mechanical brake; a hand wheel that rotates the load sheave via the mechanical brake;

a high-torque input member coupled to the hand wheel and configured to transmit a high load; a magnetic clutch coupled to the hand wheel via a speed-increasing mechanism and configured to transmit a low load by a magnetic force of a permanent magnet; and
output transmitting means selectively coupled to either one of the high-torque input member or the magnetic clutch in accordance with the magnitude of the load and transmits a rotational operating force of the hand wheel to the mechanical brake, wherein the hand wheel is axially supported by a drive member coupled to the output transmitting means of the mechanical brake,
the magnetic clutch is arranged between the speed-increasing mechanism and the hand wheel,
the hand wheel and the speed-increasing mechanism are coupled by a hollow input member coupled to the hand wheel and provided so as to cover the outer periphery of the magnetic clutch so as to allow transmission of torque, and the output transmitting means is fitted onto a boss portion of the drive member so as to allow torque transmission to the boss portion.

Also, the invention is also the speed-increasing mechanism characterized in that a planetary gear mechanism, the hollow input member is coupled to a planetary carrier of the planetary gear mechanism, the magnetic clutch is coupled to a sun gear of the planetary gear mechanism, a ring gear of the planetary gear mechanism is fixed to the frame, and a cover frame configured to cover the hand wheel is provided.

Also, the invention is also characterized in that the drive shaft penetrates a center hole provided in the sun gear and is supported at a distal end thereof by a bearing provided on the cover frame.

### Advantageous Effects of Invention

The hoist of the present invention is, as described above, configured in such a manner that
the hand wheel is axially supported by the drive member coupled to the output transmitting means of the mechanical brake and configured to be rotated thereby, the magnetic clutch is arranged between the speed-increasing mechanism and the hand wheel,
the hand wheel and the speed-increasing mechanism are coupled by the hollow input member provided so as to cover the outer periphery of the magnetic clutch so as to allow transmission of torque, and
the output transmitting means is fitted onto the boss portion of the drive member so as to allow torque transmission to the boss portion.
   Therefore, although the large-diameter bearing is required in the device of the related art since a configuration of supporting the outer periphery of the input rotating member by the bearing provided on the outer peripheral frame is required, the large-diameter bearing is not required in the present invention because the hand wheel and the output transmitting means are supported by the drive member of the mechanical brake, reduction in size is enabled. Also, since the magnetic clutch is surrounded by the hollow input member and the speed-increasing mechanism, entry of dust or the like into the magnetic clutch may be prevented.

Also, by providing the planetary gear mechanism as the speed-increasing mechanism, the thickness of the device is reduced, and since the planetary carrier and the sun gear are rotated about the same center of rotation, the hand wheel can be rotatably supported by the drive member and the planetary carrier of the planetary gear mechanism, so that the hand wheel may be axially supported stably and reduction in size of the device is enabled.

Also, since the planetary gear mechanism, the magnetic clutch, and the hand wheel are axially supported by the drive shaft, bearing is achieved desirably and the configuration of the device may be simplified and reduced in size as a whole, whereby a low cost is achieved and reduction of the offset amount between the hand wheel and the load chain is achieved, so that the hoist in which occurrence of deflection during the operation is prevented may be provided.

### BRIEF DESCRIPTION OF DRAWINGS

FIG. 1 is a cross-sectional side view of a hoist of the present invention.

FIG. 2 is an explanatory configuration drawing of a magnetic clutch.

FIG. 3 is an explanatory configuration drawing of a high-torque input member.

FIG. 4(a) is a cross-sectional side view illustrating a low-torque transmitting state, and FIG. 4(b) is an explanatory configuration drawing of FIG. 4(a).

FIG. 5(a) is a cross-sectional side view illustrating a high-torque transmitting state, and FIG. 5(b) is an explanatory configuration drawing of FIG. 5(a).

FIG. 6 is an explanatory drawing of a clutch projection and a high-torque input member in the high-torque transmitting state.

FIG. 7 is an explanatory configuration drawing of a ratchet.

FIG. 8 is an explanatory configuration drawing of a planetary gear mechanism.

### DESCRIPTION OF EMBODIMENTS

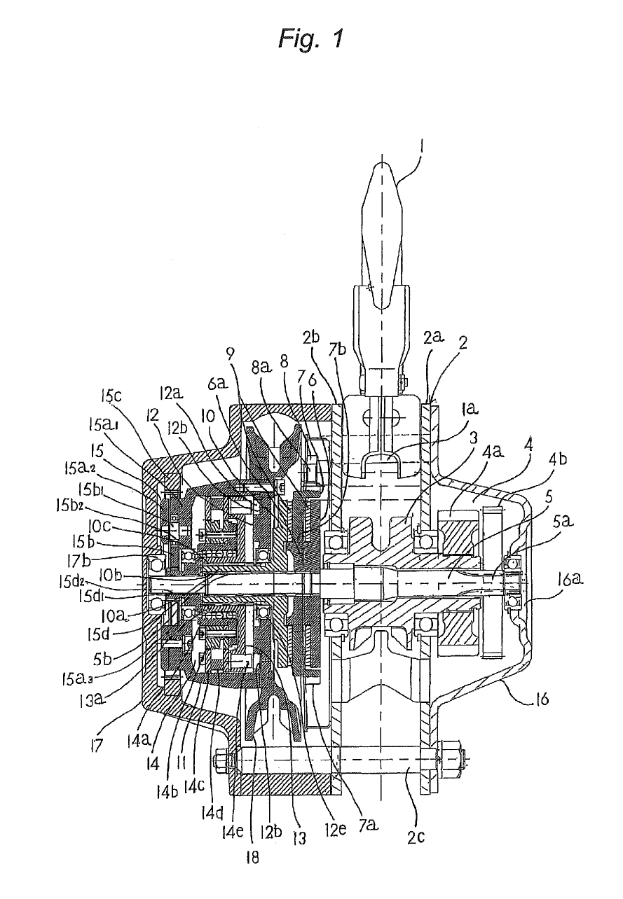

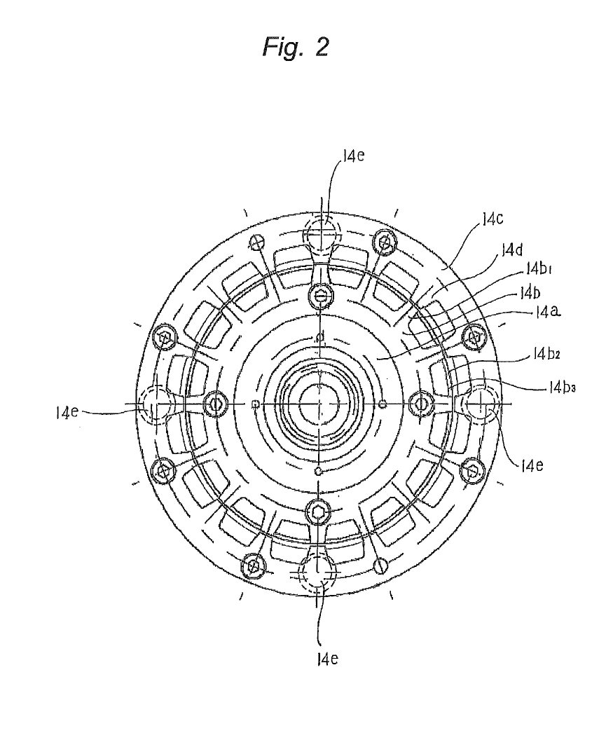

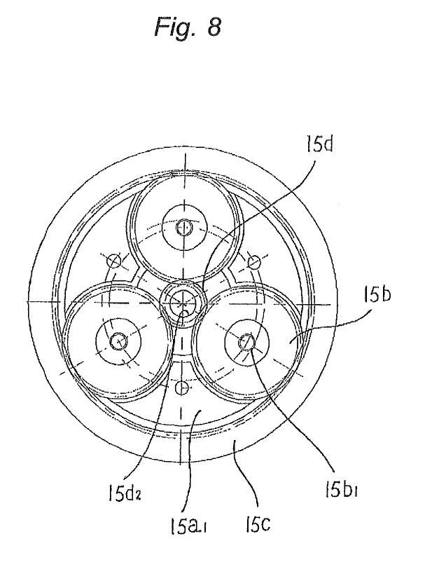

Referring now to FIG. 1 to FIG. 8, an embodiment of a load sensitive automatic speed change device of the present invention and a hoist (chain block) with the same therein will be described.

In the drawing, reference sign 1 denotes an upper hook of the hoist, reference sign la denotes an upper hook mounting shaft configured to secure the upper hook 1 to a body frame 2, reference sign 2 denotes the body frame provided with a load sheave and a speed-reduction gear bearing, reference signs 2a, 2b denote steel-plate frames of the body frame 2 having a load sheave 3 interposed therebetween, and reference sign 2c denotes a coupling shaft configured to couple the steel-plate frames 2a, 2b, and the body frame 2 includes the steel-plate frames 2a, 2b and the coupling shaft 2c, reference sign 3 denotes the load sheave axially supported between the steel-plate frames 2a, 2b so as to be rotatable and configured to hoist and lower a load chain, not illustrated, reference sign 4 denotes a speed-reduction gear mechanism, and reference sign 4a denotes a load gear spline-coupled to a boss portion of the load sheave 3, reference sign 4b denotes a speed-reduction gear (large) engaging a pinion 5a of a drive shaft 5 and mounted via a shaft coaxially with a speed-reduction gear (small), not illustrated, engaging the load gear 4a, and the rotation of the drive shaft 5 is transmitted to the load sheave 3 with decreased speed. Reference sign 5 denotes the drive shaft inserted into a through hole of the load sheave 3 so as to be rotatable and is provided with the pinion 5a at one end and a male screw 5b at the other end. The drive shaft 5 is axially supported at a distal end on the side of the pinion 5a on a cover frame 16 of the speed-reduction gear mechanism 4 by a bearing 16a, and at a distal end on the side of the male screw 5b on a cover frame 17 of a hand wheel 18 via a bearing 17b.

Reference sign 6 designates a brake pressure receiving member axially mounted on the drive shaft 5 so as not to be rotatable, and a pair of friction discs 9, 9 and a reverse rotation preventing ratchet 7 sandwiched between the friction discs 9, 9 are rotatably fitted on a boss portion 6a thereof.

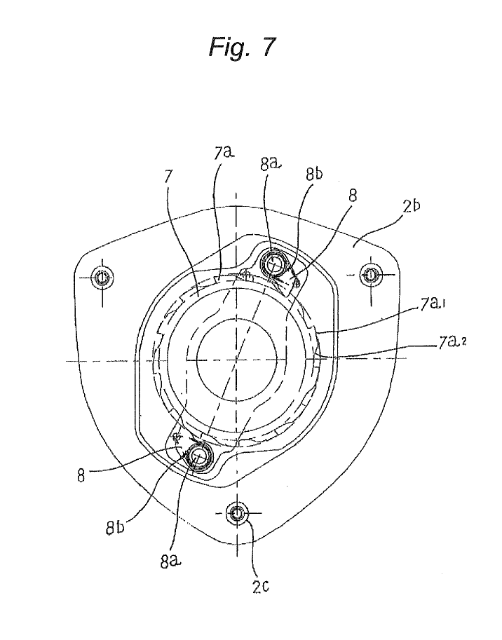

Reference sign 7a denotes a tooth portion of the reverse rotation preventing ratchet 7, and the tooth portion 7a is provided with a first bevel 7a₁ and a second bevel 7a₂, described later, as illustrated in FIG. 7. Reference sign 7b denotes a slide bearing, reference sign 8 designates a claw, reference sign 8a denotes a claw shaft and reference sign 8b denotes a spring urging the claw 8 toward the ratchet 7.

The first bevel 7a₁ provided on the tooth portion 7a of the reverse rotation preventing ratchet 7 includes a bevel provided so that the claw 8 abuts against the tooth portion 7a about the claw shaft 8a at a gentle angle when the rotation of the hand wheel 18 is rotated at a high speed via the planetary gear mechanism 15. The second bevel 7a₂ is a bevel provided so that the claw 8 rotates about the claw shaft 8a to an extent larger than the first bevel 7a₁ and abuts reliably against the tooth portion 7a, and configured to engage the claw 8 deeply to reliably prevent the reverse rotation of the ratchet 7.

In this manner, with the provision of the first bevel 7a₁ configured to allow the claw 8 to abut gently against the tooth portion 7a of the reverse rotation preventing ratchet 7 and the second bevel 7a₂ configured to allow the same to abut strongly against the tooth portion 7a, generation of noises of the claw 8 and the ratchet 7 generated when the ratchet 7 rotates at a high-speed may be prevented and a reverse rotation preventing function may be achieved reliably at a high-torque rotation.

Reference sign 10 denotes a drive member of a mechanical brake, includes a female screw 10b on an inner peripheral portion of a boss portion 10a and a spline 10c on an outer periphery portion thereof, causes the female screw 10b to engage the male screw 5b of the drive shaft 5 and rotate in the forward direction (hoisting operation) to press the friction discs 9, 9 and the reverse rotation preventing ratchet 7 toward the brake pressure receiving member 6 with a braking surface thereof and transmits the rotation of the drive member 10 to the drive shaft 5, and causes the female screw 10b to rotate in a reverse direction (lowering operation) to slide in a direction opposite to the pressing direction to release the frictional engagement with the reverse rotation preventing ratchet 7 and allow the reverse rotation (lowering). The drive member 10 constitutes an input portion of the mechanical brake, which is to be rotated and driven.

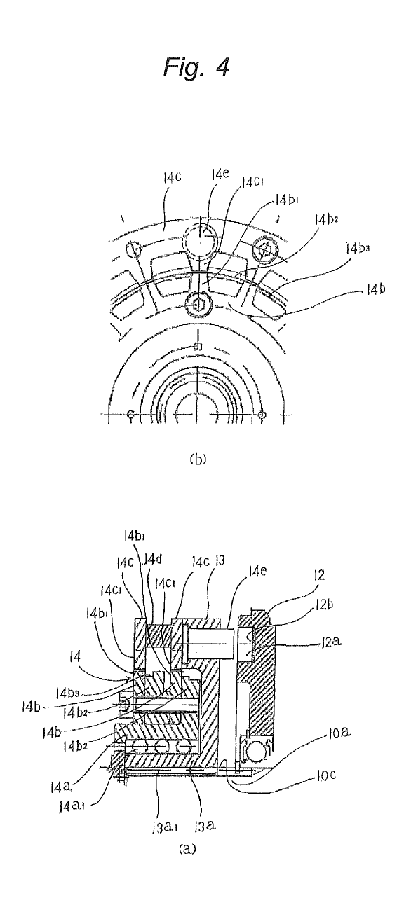

The boss portion 10a is a hollow shaft-shaped boss portion extending from the drive member 10 in the direction of the side surface of the cover frame 17 of the hand wheel 18, described later, in the direction opposite to the braking surface which presses the friction disc 9, 9, a boss portion 13a of an output transmitting member 13, illustrated in FIG. 4(a) and described later, is loosely fitted to the spline 10c provided on the outer periphery of the boss portion 10a so as to be slidable by means of a spline 13a₁ provided on the inner periphery of the boss portion 13a in the axial direction, and the drive member 10 and the output transmitting member are coupled so as to allow transmission of the torque. Furthermore, a hollow input shaft 14a of a magnetic clutch 14, described later, is supported on the outer periphery of the boss portion 13a so as to be capable of moving relative to each other to allow the rotation and sliding movement in the direction of the axis of rotation by a bearing 14a₁.

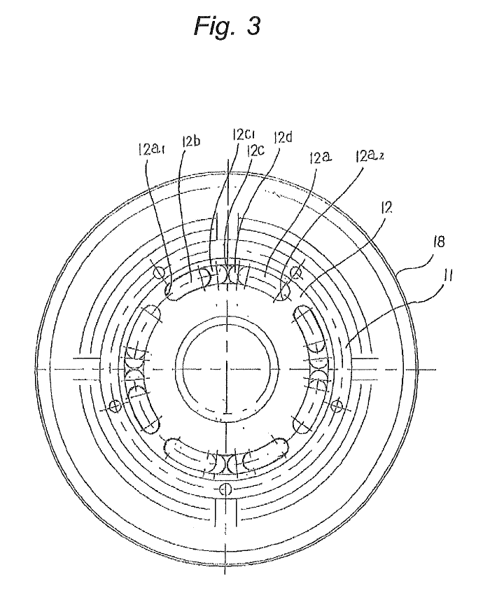

Reference sign 11 denotes a non-magnetic hollow shaft-shaped hollow input member secured to the hand wheel 18 and reference sign 12 denotes a high-torque input member coupled to the hollow input member 11 and the hand wheel 18 so as to rotate integrally. A carrier 15a₁ of a planetary gear mechanism 15, described later, is integrally coupled to the other side of the hollow input member 11. Also, the hollow input member 11 includes a peripheral wall configured to cover the outer peripheries of the magnetic clutch 14 and the output transmitting member 13. Reference sign 12a denotes an engaging depression of a claw clutch provided on the high-torque input member 12, constitutes the claw clutch engaging and disengaging a clutch projection 14e, described later, and includes a forward rotation torque transmitting side surface 12a₁ configured to engage the clutch projection 14e at the time of forward rotation of the high-torque input member 12 illustrated in FIG. 3 and a reverse rotation torque transmitting side surface 12a₂ engaging the clutch projection 14e at the time of reverse rotation. Reference sign 12b denotes a clutch holding magnetic body provided on a bottom surface of a depression of the engaging depression 12a and configured to attract the clutch projection 14e. The clutch projection 14e is formed of a ferromagnetic body excited by a permanent magnet 14d, and is configured to be attracted by the clutch holding magnetic body 12b when the clutch projection 14e moves toward the engaging depression 12a of the high-torque input member 12 through a clutch switching action, described later, and is retained by the same. The high-torque input member 12 is formed of a non-magnetic body except for the clutch holding magnetic body so as not attract the clutch projection 14e.

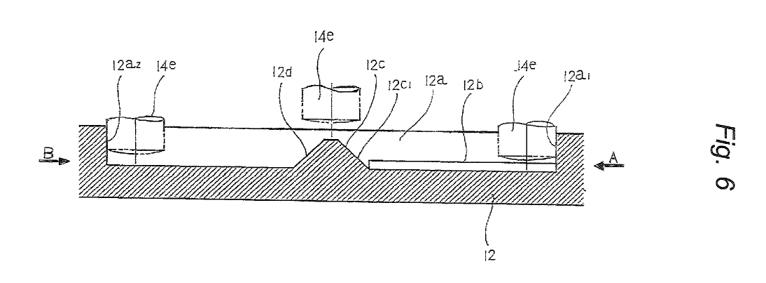

Reference sign 12c denotes a clutch disengaging projection formed of a non-magnetic body provided on an intermediate portion between the forward rotation torque transmitting side surface 12a₁ and the reverse rotation torque transmitting side surface 12a₂ of the engaging depression 12a, and includes a clutch disengaging bevel 12c₁ configured to abut against the clutch projection 14e by rotating the hand wheel 18 in the reverse direction to forcedly disengage the clutch projection 14e and the clutch holding magnetic body 12b at the time of the hoisting operation and a restricting bevel 12d configured to restrict the movement of the clutch projection 14e so as to prevent the clutch projection 14e from being attracted by the clutch holding magnetic body 12b at the time of the lowering operation. The clutch disengaging projection 12c has a function to move the clutch projection 14e relatively from the forward rotation torque transmitting side surface 12a₁ toward the reverse rotation torque transmitting side surface 12a₂ by rotating the high-torque input member 12 in the reverse direction as illustrated in FIG. 6 so as to allow the clutch projection 14e attracted by the clutch holding magnetic body 12b on the side of the forward rotation torque transmitting side surface 12a₁ to abut against the clutch disengaging bevel 12c₁ of the clutch disengaging projection 12c during the relative movement to disengage the clutch projection 14e from the clutch holding magnetic body 12b as illustrated at a center position in FIG. 6. Even when being disengaged from the engaging depression 12a once, when a load torque reaches a predetermined value or higher, the clutch projection 14e is slid to the interior of the engaging depression 12a again, abuts against the forward rotation torque transmitting side surface 12a₁ or the reverse rotation torque transmitting side surface 12a₂ depending on the direction of rotating the hand wheel 18, and transmits a rotational torque.

Reference sign 15 denotes the planetary gear mechanism acting as a speed-increasing mechanism, reference sign 15a₁ denotes the planetary carrier coupled to the hollow input member 11, reference sign 15a₂ is a planetary carrier constituting a pair with the planetary carrier 15a₁, reference sign 15b denotes a planetary gear axially supported by the planetary carriers 15a₁, 15a₂ so as to be rotatable, reference sign 15b₁ designates a planetary gear shaft implanted in the planetary carriers 15a₁, 15a₂, reference sign 15c denotes a ring gear which allows inscribing engagement of the planetary gear 15b, reference sign 15d designates a sun gear provided on a sun gear shaft 15d₁, reference sign 15d₁ denotes the sun gear shaft as an output shaft of the speed-increasing mechanism. The planetary gear 15b comes into a circumscribing engagement with the sun gear 15d and comes into inscribing engagement with the ring gear 15c, increases the rotation of the planetary carrier 15a₁, and rotates the sun gear shaft 15d₁ at an increased speed.

The planetary gear mechanism 15 including the planetary carrier 15a₁ to the sun gear 15d is arranged between the side surfaces of the boss portion 10a of the drive member 10 and the cover flame 17 as illustrated in FIG. 1. A center hole 15d₂ which allows insertion of the drive shaft 5 is provided at centers of the sun gear 15d and the sun gear shaft 15d₁.

Reference sign 14 designates the magnetic clutch, including the hollow input shaft 14a coupled to the sun gear shaft 15d₁ so as to allow transmission of the rotational power and an inner yoke 14b provided on the outer periphery of the hollow input shaft 14a and formed of a soft magnetic body, is provided with the permanent magnet 14d and an outer yoke 14c excited by the permanent magnet 14d on the outer periphery of the inner yoke 14b, so that the torque transmittable by a magnetic attracting force acting therebetween is transmitted between the inner yoke 14b and the outer yoke 14c. The hollow input shaft 14a has a length substantially the same as that of the boss portion 13a of the output transmitting member 13, is arranged so as to be overlapped with the outer periphery of the boss portion 13a in the direction of the axis of rotation, and is axially supported by the bearing 14a₁ so as to be rotatable and axially slidable with respect to the boss portion 13a.

The outer yoke 14c is secured to the output transmitting member 13 together with the permanent magnet 14d, the spline 13a₁ is provided on the inner periphery of the boss portion 13a of the output transmitting member, the spline 13a₁ is coupled to the spline 10c on the outer periphery of the boss portion 10a of the drive member 10 so as to be slidable in the axial direction, and the outer yoke 14c is coupled to the outer periphery of the hollow shaft-shaped boss portion 10a of the drive member 10 so as to be incapable of rotating relatively to the drive member 10.

In order to enhance the torque transmittable between the outer yoke 14c and the inner yoke 14b by the magnetic force, the permanent magnet 14d has a doughnut disc shape and is polarized into an N-pole on one side surface and into an S-pole on the other side surface, and the permanent magnet 14d is held between a pair of outer yokes 14c, 14c, a pair of inner yokes 14b, 14b are arranged on the inner periphery of the pair of outer yokes 14c, 14c so as to face each other and, in addition, tooth-shaped portions 14c₁, 14b₁ having a plurality of tooth tips arranged are provided on inner and outer peripheral surfaces of the outer yoke 14c and the inner yoke 14b facing each other so that the tooth tips thereof face each other.

Reference sign 14b₂ denotes a doughnut disc-shaped side magnetic body fitted on the hollow input 14a of the magnetic clutch 14 on the side surface of the tooth-shaped portion 14b₁, and reference sign 14b₃ denotes a small-diameter portion of the side magnetic body.

Reference sign 14e is the clutch projection constituting the claw clutch which is formed a ferromagnetic body. The clutch projection 14e is provided so as to project from the output transmitting member 13 toward the high-torque input member 12, engages the engaging depression 12a provided on the high-torque input member 12 at the time of the high-load rotation, and is attracted by the clutch holding magnetic body 12b provided on the engaging depression 12a.

The magnetic clutch 14 is fitted on the outer periphery of the boss portion 10a of the drive member 10 in a space surrounded by the hollow portion of the hollow input member 11, the carrier 15a₁ of the planetary gear mechanism 15 provided on one side of the hollow input member 11, and the high-torque input member 12 provided on the other side as illustrated in FIG. 1.

Reference sign 18 denotes the hand wheel as rotation torque input means, and is secured to the hollow input member 11 and the high-torque input member 12 with coupling means. Also, the hand wheel 18 is axially supported on the boss portion 10a of the drive member 10 together with the high-torque input member 12 via a bearing 12e so as to be rotatable, and is axially supported on the outer periphery of the sun gear shaft 15d₁ by a bearing 15a₃ via the hollow input member 11 and the planetary carrier 15a₁ so as to be rotatable. The sun gear shaft 15d₁ is secured on the hollow input shaft 14a supported on the outer periphery of the hollow-shaft shaped boss portion 13a of the output transmitting member 13 by the wide bearing 14a₁ so as to extend in the axial direction. The boss portion 13a of the output transmitting member 13 of the magnetic clutch 14 is slidably fitted to the hollow-shaft shaped boss portion 10a of the drive member 10 via the splines 10c, 13a₁. The drive member 10 is screwed to the drive shaft 5 with the male screw 5b and the female screw 10b via the boss portion 10a, and the drive shaft 5 is supported by the cover frames 16, 17 secured to the frame 2 respectively by the bearings 16a, 17b at the distal ends thereof. Therefore, the hand wheel 18, the magnetic clutch 14, and the output transmitting member 13 are supported on the drive shaft 5 via the respective bearing portions described above, and rotate concentrically with the drive shaft 5.

Subsequently, a switching action of the magnetic clutch mechanism of the present invention will be described.

At the time of low-load rotation in which there is no load to be hung or the load to be hung is light and hence the load required to rotate the hand wheel 18 is small, as illustrated in FIGS. 4(a) and (b), the tooth-shaped portion 14b₁ of the inner yoke 14b and the tooth-shaped portion 14c₁ of the outer yoke 14c secured to the output transmitting member 13 are in a state of facing each other, so that the tooth-shaped portion 14c₁ of the outer yoke 14c excited by the permanent magnet 14d and the tooth-shaped portion 14b₁ provided on the inner yoke 14b form a magnetic circuit via gaps between tooth tips of the tooth-shaped portion of the both, and a strong magnetic attracting force is generated between the both rotating means.

In this state, a component force of an attracting force caused by a magnetic force between the tooth-shaped portion 14c₁ of the outer yoke 14c and the tooth-shaped portion 14b₁ of the inner yoke 14b in the direction of center line of rotation is in balance with that in the direction of center line of rotation of the attracting force caused by the magnetic force between the outer yoke 14c and the side magnetic body 14b₂, and the tooth-shaped portion 14b₁ of the inner yoke 14b and the tooth-shaped portion 14c₁ of the outer yoke 14c maintain the state illustrated in FIGS. 4(a) and (b), transmit the torque from the tooth-shaped portion 14b₁ of the inner yoke 14b to the tooth-shaped portion 14c₁ of the outer yoke 14c, and rotate the outer yoke 14c at the same speed as the sun gear shaft 15d₁ increased in speed at a predetermined speed increasing ratio.

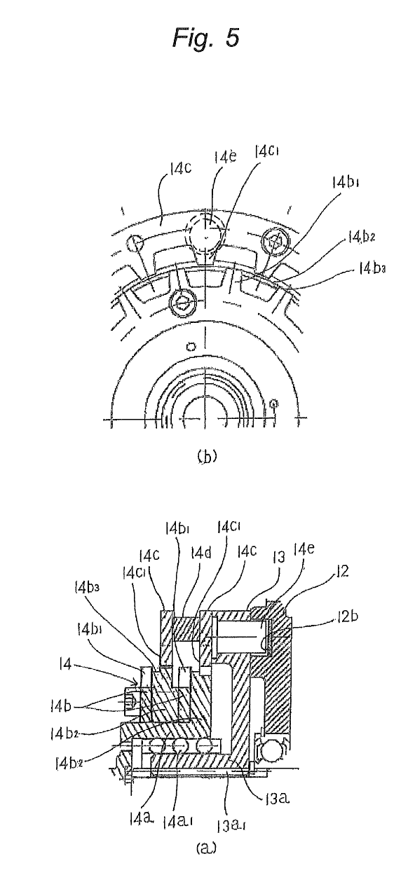

Subsequently, when the load torque is increased by hoisting a heavy load and hence the load torque exceeds the magnetic attracting force between the tooth-shaped portion 14b₁ of the inner yoke 14b and the tooth-shaped portion 14c₁ of the outer yoke 14c, the inner yoke 14b and the outer yoke 14c rotate relative to each other, and the magnetic circuit formed between the tooth tips of the tooth-shaped portion of the tooth-shaped portion 14c₁ of the outer yoke 14c and the tooth-shaped portion 14b₁ of the inner yoke 14b is displaced to the magnetic circuit flowing through the side magnetic body 14b₂, so that the component force of the attracting force in the direction of center line of rotation caused by the magnetic force between the tooth-shaped portion 14c₁ of the outer yoke 14c and the tooth-shaped portion 14b₁ of the inner yoke 14b is reduced. In contrast, a component force of the attracting force caused by the magnetic force between the outer yoke 14c and the side magnetic body 14b₂ in the direction of center line of rotation is increased. When the component force of the attracting force caused by the magnetic force between the outer yoke 14c and the side magnetic body 14b₂ in the direction of center line of rotation is increased to a level larger than the component force of the attracting force caused by the magnetic force between the tooth-shaped portion 14c₁ of the outer yoke 14c and the tooth-shaped portion 14b₁ of the inner yoke 14b in the direction of center line of rotation, the outer yoke 14c slides in the direction of the center line of rotation, the relative position between the tooth-shaped portion 14c₁ of the outer yoke 14c and the tooth-shaped portion 14b₁ of the inner yoke 14b is displaced, whereby the magnetic circuit is formed between the tooth-shaped portion 14c₁ of the outer yoke 14c and the side magnetic body 14b₂ as illustrated in FIGS. 5(a) and (b) and, simultaneously, the clutch projection 14e sliding together with the outer yoke 14c engages the engaging depression 12a of the high-torque input member 12 rotating at the same speed as the hand wheel 18 and is attracted by the clutch holding magnetic body 12b, so that the mode is switched to a high-load transmission mode.

Subsequently, when the load is lowered to a level lower than the predetermined value after having uncharged, the tooth-shaped portion 14c₁ of the outer yoke 14c and the tooth-shaped portion 14b₁ of the inner yoke 14b face each other by the magnetic force and the magnetic circuit formed between the outer yoke 14c and the side magnetic body 14b₂ is switched to the magnetic circuit flowing through the tooth-shaped portion 14b₁ of the inner yoke 14b, so that the component force of the attracting force caused by the magnetic force between the tooth-shaped portion 14c₁ of the outer yoke 14c and the tooth-shaped portion 14b₁ of the inner yoke 14b in the direction of center line of rotation is increased and the component force of the attracting force caused by the magnetic force between the outer yoke 14c and the side magnetic body 14b₂ in the direction of center line of rotation is reduced, whereby the component force of the attracting force caused by the magnetic force between the tooth-shaped portion 14c₁ of the outer yoke 14c and the tooth-shaped portion 14b₁ of the inner yoke 14b in the direction of center line of rotation exceeds the component force of the attracting force caused by the magnetic force between the outer yoke 14c and the side magnetic body 14b₂ in the direction of center line of rotation. Therefore, a returning thrust force is generated, and the tooth-shaped portion 14c₁ of the outer yoke 14c is slid to a position facing the tooth-shaped portion 14b₁ of the inner yoke 14b, so that the low-load transmission mode is achieved.

When the hoisting operation of the hand wheel 18 is stopped in a state of having a load hung therefrom in a hoist provided with the mechanical brake operated by the load, the load applied by the load hung therefrom is held by the reverse rotation preventing ratchet 7 of the mechanical brake, and hence the load applied between the inner yoke 14b and the outer yoke 14c disappears. When the engagement of the claw clutch is released in the same manner as a low-load state after having uncharged in the state described above, a switching action from the low-load state (low-load transmission mode) to a high-load state (high-load transmission mode) by the magnetic clutch 14 and the claw clutch is executed every time when the hoisting operation of the hand wheel 18 is started. However, in this embodiment, when the mode is switched to the high-load transmission mode by the hoisting action, the clutch holding magnetic body 12b attracts the clutch projection 14e to prevent the claw clutch from returning, so that the occurrence of a shock caused by the switching action described above is prevented.

When the lowering operation (the operation to rotate the hand wheel 18 in the reverse direction) after having hoisted the load, as illustrated in FIG. 6, the clutch projection 14e moves away from the forward rotation torque transmitting side surface 12a₁ of the high-torque input member 12 beyond the clutch disengaging bevel 12c₁ provided on the clutch disengaging projection 12c toward the reverse rotation torque transmitting side surface 12a₂ side and abut against the same, transmits a high-load torque in the reverse direction, and lowers the load.

Since the clutch holding magnetic body 12b is not arranged between the reverse rotation torque transmitting side surface 12a₂ and the clutch disengaging projection 12c, the claw clutch and the magnetic clutch return to the low-load transmission mode automatically when the no-load state is achieved by being uncharged, and the load is lowered at a high speed so that the hoisting is allowed.

When the clutch projection 14e is attracted by the clutch holding magnetic body 12b at the time of low-load rotation in which there is no load to be hung or the load to be hung is light and hence the load required to rotate the hand wheel 18 is light, by rotating the hand wheel 18 in the reverse direction to rotate the high-torque input member 12 in the reverse direction, so that the clutch projection 14e is moved from the forward rotation torque transmitting side surface 12a₁ of the engaging depression 12a provided on the high-torque input member 12 to the reverse rotation torque transmitting side surface 12a₂ side as illustrated in FIG. 6 and, during this moving action, the clutch projection 14e abuts against the clutch disengaging bevel 12c₁ of the clutch disengaging projection 12c and is guided by the bevel to be disengaged from the clutch holding magnetic body 12b, while the outer yoke 14c slides to a position facing the tooth-shaped portion 14b₁ of the inner yoke 14b and is switched to the low-load transmission mode.

According to this embodiment, since the switching of the claw clutch provided on the output transmitting member 13 secured on the outer yoke 14c and the claw clutch provided on the high-torque input member 12 is conducted by sliding the outer yoke 14c using the thrust force generated by the relative rotation between the tooth-shaped portion 14c₁ of the outer yoke 14c and the tooth-shaped portion 14b₁ provided on the inner yoke 14b by the load applied to the magnetic clutch 14, a thrust conversion mechanism provided separately, which is an device required in the device of the related art is not necessary to be provided, so that the number of components is reduced, the structure is simplified, reduction in size and weight is enabled, the manufacturing cost is significantly reduced. Also, at the time of high load, since the clutch projection 14e provided on the outer yoke 14c is configured as the claw clutch engaging the high-torque input member 12 by the thrust force generated by the relative rotation of the outer yoke 14c and the inner yoke 14b, the power transmission may be performed accurately even at the time of high load, and also the switching of the clutch may be performed at a high response.

In addition, since the clutch holding magnetic body 12b is provided on the engaging depression 12a of the high-torque input member 12, the clutch projection 14e is attracted by the clutch holding magnetic body 12b when the output transmitting member 13 switches from the inner yoke 14b to the high-torque input member 12, a switching action may be performed quickly and reliably by the clutch projection 14e. Also, since the clutch projection 14e is attracted constantly by the clutch holding magnetic body 12b at the time of the hoisting operation in the high-load transmission mode, occurrence of the clutch return may be prevented.

In addition, since the clutch disengaging projection 12c is provided at the intermediate portion between the forward rotation torque transmitting side surface 12a₁ and the reverse rotation torque transmitting side surface 12a₂ of the engaging depression 12a, the clutch projection 14e is moved from the forward rotation torque transmitting side surface 12a₁ to the reverse rotation torque transmitting side surface 12a₂ side by rotating the high-torque input member 12 in the reverse direction at the time of action of the output rotating means 13 switching from the high-torque input member 12 to the inner yoke 14b of the magnetic clutch 14 and, during this moving action, the clutch projection 14e abuts against the clutch disengaging bevel 12c₁ to cause the clutch projection 14e to be disengaged from the clutch holding magnetic body 12b, so that the output rotating means 13 may be switched from the high-torque input member 12 to the inner yoke 14b of the magnetic clutch 14, which is the low-torque input means, and may be switched to the low-load transmitting mode smoothly.

Also, according to the present invention,
the hand wheel 18 is axially supported by the drive member 10 coupled to the output transmitting means 6 of the mechanical brake and rotated thereby,
the magnetic clutch 14 is arranged between the speed-increasing mechanism 15 and the hand wheel 18,
the hollow input member 11 configured to couple the hand wheel 18 and the speed-increasing mechanism 15 so as to allow torque transmission and so as to cover the outer periphery of the magnetic clutch 14 is provided, and
the output transmitting means 6 is fitted onto the boss portion 10a of the drive member 10 so as to allow torque transmission to the boss portion.
   Therefore, although the large-diameter bearing is required in the device of the related art since a configuration of supporting the outer periphery of the input rotating member by the bearing provided on the outer peripheral frame is required, the large-diameter bearing is not required in the present invention because the hand wheel 18 and the output transmitting member 13 are supported by the drive member 10 of the mechanical brake, reduction in size is enabled. Also, since the magnetic clutch 14 is surrounded by the inner peripheral wall of the hollow input member 11 formed of a non-magnetic member and the speed-increasing mechanism, entry of dust or the like into the magnetic clutch may be prevented.

Also, by providing the planetary gear mechanism 15 as the speed-increasing mechanism, the thickness of the device is reduced, and since the planetary carrier 15a and the sun gear 15d are rotated about the same center of rotation, the hand wheel 18 can be rotatably supported by the drive member 10 and the planetary carrier 15a of the planetary gear mechanism, so that the hand wheel 18 may be axially supported stably and reduction in size of the device is enabled.

Also, since the planetary gear mechanism 15, the magnetic clutch 14, and the hand wheel 18 are axially supported by the drive shaft 5, bearing is achieved desirably and the configuration of the device may be simplified and reduced in size as a whole, whereby a low cost is achieved and reduction of the offset amount between the hand wheel and the load chain is achieved, so that a hoist in which occurrence of deflection during the operation is prevented may be provided.

### REFERENCE SIGNS LIST

3 load sheave

4 speed-reduction gear mechanism

5 drive shaft

5a pinion

5b multi-thread male screw

6 brake pressure receiving member

6a boss portion

7 ratchet

7a tooth portion

7a₁ first bevel

7a₂ second bevel

8 claw

8a claw shaft

9 friction disc

10 drive member

10a boss portion

10b multi-thread female screw

10c spline

11 hollow input member

12 high-torque input member

12a engaging depression

12b clutch holding magnetic body

12c clutch disengaging projection

12e bearing

13 output transmitting member

13a boss portion of output transmitting member

13a₁ spline

14 magnetic clutch

14a hollow input shaft

14b inner yoke

14b₁ tooth-shaped portion

14b₂ side magnetic body

14b₃ small-diameter portion

14c outer yoke

14c₁ tooth-shaped portion

14d permanent magnet

14e clutch projection

15 planetary gear mechanism

15a₁ carrier 1

15a₂ carrier 2

15b₂ bearing

15c ring gear

15d sun gear

15d₁ sun gear shaft

16 cover frame

16a drive shaft bearing

17 cover frame

17b drive shaft bearing

18 hand wheel

1. A hoist with built-in load sensitive automatic speed change device comprising:
a speed-reducing mechanism configured to drive a load sheave axially supported by a frame on one side of the load sheave and a mechanical brake which applies a brake force by a load applied to the load sheave on the other side thereof;
a drive shaft configured to couple the speed-reducing mechanism and the mechanical brake; a hand wheel that rotates the load sheave via the mechanical brake;
a high-torque input member coupled to the hand wheel and configured to transmit a high load; a magnetic clutch coupled to the hand wheel via a speed-increasing mechanism and configured to transmit a low load by a magnetic force of a permanent magnet; and
output transmitting means selectively coupled to either one of the high-torque input member or the magnetic clutch in accordance with the magnitude of the load and transmits a rotational operating force of the hand wheel to the mechanical brake, wherein
the hand wheel is axially supported by a drive member coupled to the output transmitting means of the mechanical brake and configured to be rotated thereby,
the magnetic clutch is arranged between the speed-increasing mechanism and the hand wheel,
the hand wheel and the speed-increasing mechanism are coupled by a hollow input member coupled to the hand wheel and provided so as to cover the outer periphery of the magnetic clutch so as to allow transmission of torque, and
the output transmitting means is fitted onto a boss portion of the drive member so as to allow torque transmission to the boss portion.

2. The hoist according to claim 1, wherein the speed-increasing mechanism is a planetary gear mechanism, the hollow input member is coupled to a planetary carrier of the planetary gear mechanism, the magnetic clutch is coupled to a sun gear of the planetary gear mechanism, a ring gear of the planetary gear mechanism is fixed to the frame, and a cover frame configured to cover the hand wheel is provided.

3. The hoist according to claim 2, wherein the drive shaft penetrates a center hole provided in the sun gear and is supported at a distal end thereof by a bearing provided on the cover frame.
